(19) United States
(12) Patent Application Publication
(10) Pub. No.: US 2008/0095560 A1
(43) Pub. Date: Apr. 24, 2008

(54) ADJUSTING A LINE

(75) Inventors: Bradley R. Larson, Meridian, ID (US); Wei Hu Cheng, Garden City, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company LP

(21) Appl. No.: 11/551,241

(22) Filed: Oct. 20, 2006

(51) Int. Cl. G03G 15/00

(52) U.S. Cl. 399/394

(57) ABSTRACT

Embodiments of adjusting a line of an image using a determined skew of a sheet are disclosed.

### BACKGROUND

During printing, sheets of media are sometimes skewed which leads to printed images being misaligned with edges of the sheet.

### BRIEF DESCRIPTION OF THE DRAWINGS

FIG. 1 is a schematic illustration of a printer according to one example embodiment.

FIG. 2 is a top plan view of a sheet of media illustrating the sensing of skew of a first portion of the sheet as the sheet is being moved in a feed direction according to one example embodiment.

FIG. 3 is a top plan view of the sheet of FIG. 2 illustrating image lines printed upon the sheet based upon a detected skew of the first portion of the sheet.

FIG. 4 is a top plan view of the sheet of FIG. 2 illustrating the sensing of skew of a second portion of the sheet as the sheet is being moved in a feed direction according to one example embodiment.

FIG. 5 is a top plan view of the sheet of FIG. 4 illustrating image lines printed upon the sheet based upon a detected skew of the second portion of the sheet according to an example embodiment.

FIG. 6 is a fragmentary top plan view of a portion of an imaging surface illustrating adjusting exposure of the imaging surface to compensate for skew according to an example embodiment.

FIG. 7 is a plan view of the sheet of FIG. 2 illustrating the sensing of skew of a third portion of the sheet as the sheet is being moved in a feed direction according to one example embodiment.

FIG. 8 is a top plan view of the sheet of FIG. 7 illustrating image lines printed upon the sheet based upon a detected skew of the third portion of the sheet according to an example embodiment.

### DETAILED DESCRIPTION OF THE EXAMPLE EMBODIMENTS

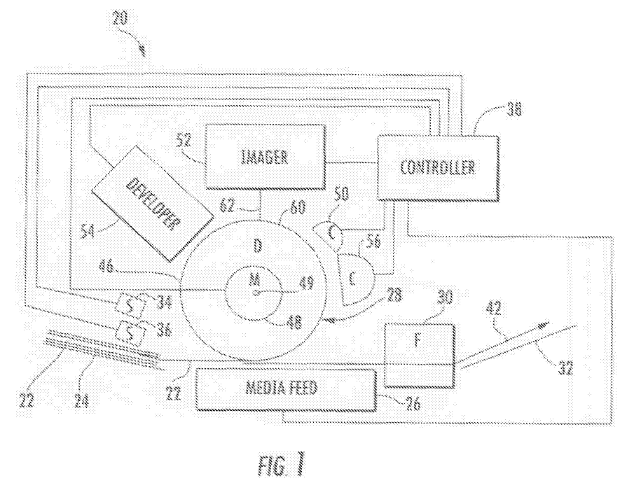

FIG. 1 schematically illustrates printer 20 according to one example embodiment. Printer 20 is configured to form an image upon a sheet 22 of print media. Printer 20 is further configured to sense and adjust for skew of the sheet 22. Printer 20 generally includes input 24, media feed 26, printing device 28, fuser 30, output 32, sensors 34, and 36 and controller 38. Input 24 comprises one or more structures configured to guide and store sheets 22 of media until such sheets are individually transported to printing device 28 by media feed 26. In one embodiment, input 24 may comprise a tray. In other embodiments, input 24 may comprise a drawer, bin and the like.

Media feed 26 comprises a mechanism configured to engage a sheet 22 of media so as to move the sheet 22 from input 24 to printing device 28 and subsequently from printing device 28 to fuser 30. In one embodiment, media feed 26 comprises an arrangement of one or more rollers or one or more belts driven by one or more motors and associated transmissions. In another embodiment, media feed 26 may comprise a drum or cylinder against which sheet 22 is held and moved to printing device 28. In other embodiments, media feed 26 may comprise other mechanism or structures configured to move sheets 22 from input 24 in a feed direction along a media feed path as indicated by arrow 42. In still other embodiments, media feed 26 may additionally be configured to overturn sheets 22 of media after one side of such sheets is printed upon and return such sheets 22 back to printing device 28 for duplex printing.

Printing device 28 comprises an arrangement of elements or components configured to deposit and pattern printing material upon sheet 22 to form a printed image upon sheet 22. In the particular about illustrated, printing device 28 comprises an electrophotographic printing device generally including drum 46, motor 48, charger 50, imager 52, developer 54 and charger eraser 56. Drum 46 comprises a cylinder configured to be rotatably driven about axis 49 by motor 48 and having an imaging surface 60 configured to selectively retain a pattern or image of electrostatic charge. In particular, surface 60 is configured to be electrostatically charged and to be selectively discharged upon receiving light from imager 52. Although surface 60 is illustrated as being supported by drum 46, surface 60 may alternatively be provided as part of an endless belt supported by a plurality of rollers. In such embodiments, the exterior surface of the endless belt may be configured to be electrostatically charged and to be selectively discharged for creating an electrostatic field in the form of an image. In yet other embodiments, surface 60 may alternatively include an array of individually chargeable pixel electrodes, wherein each pixel electrodes is independently and selectively chargeable to form an electrostatic field in the form of an image upon surface 60. In still other embodiments, an electrostatic field in the form of an image may be formed upon surface 60 with an electrostatic field emitting device located in close proximity to surface 60 such that the device creates a pattern of electrostatic fields across surface 60.

Charger 50 comprises a device configured to electrostatically charge surface 60. In one embodiment, charger 60 includes a corotron or scorotron. In other embodiments, other devices for electrostatic charging surface 60 may be employed.

Imager 52 comprises a device configured to direct a light upon surface 60 so as to form an image. In the example shown, imager 52 comprises a scanning laser which is moved across surface 60 along scan lines as drum 28 is rotated about axis 49. Those portions of surface 60 which are impinged by the light or laser beam 62 become electrically conductive and discharge elect static charge to form an image (or latent image) upon surface 60.

Although imager 52 is illustrated and described as comprising a scanning laser, imager 52 may alternatively comprise other devices configured to selectively emit or selectively allow light to impinge upon surface 60. For example, in other embodiments, imager 52 may alternatively include one or more shutter devices which employed liquid crystal materials to selectively block light and to selectively allow light to pass through to surface 60. In other embodiments, imager 52 may alternatively include shutters which include individual micro or nano light blocking shutters which pivot, slide or otherwise physically move between light blocking and light transmitting states. In those embodiments where surface 60 alternatively comprises an electrophotographic surface including an array of individual pixel electrodes configured to be selectively charged or selectively discharged using an array of switching mechanisms such as transistors or metal-insulator-metal (MIM) devices, charger 50 and imager 52 may be omitted.

Developer 54 comprising device configured to deposit printing material upon surface 60. In one embodiment, developer 54 is configured to deposit electrostatically charged dry toner upon surface 60. In yet another embodiment, developer 54 may be configured to deposit electrostatically charged liquid toner upon surface 60. In yet other embodiments, developer 54 may be configured to deposit or apply other forms of printing material upon surface 60. The electrostatically charged printing material is attracted to or repelled from selected electrostatically charged portions of a surface 60 to form a corresponding pattern or image of printing material upon surface 60. This pattern or image of printing material is subsequently transferred from surface 60 to sheet 22 either directly (as seen in FIG. 1) or indirectly via one ore more intermediate transfer drums, rollers or belts.

Charge eraser 56 comprises a device situated along surface 60 and configured to remove residual charge from surface 60. In one embodiment, charger eraser 56 may comprise an LED erase lamp. In other embodiments, charge eraser 56 may comprise other devices or may be omitted.

Fuser 30 comprises a device configured to fuse or more permanently adhere the printing material to sheet 22. In particular, fuser 30 applies heat and pressure to the printing material upon sheet 22 to fuse the printing material to sheet 22 prior to the sheet being discharged to output 32. Depending upon the printing material employed, fuser 30 may comprise various devices. In some embodiments, fuser 30 may be omitted.

Output 32 comprises one more structures configured to provide access to completed or printed upon sheets 22. Output 32 may comprise one ore more trays, bins and the like.

In operation, charger 50 forms a blanket of electrostatic charge across surface 60. Imager 52 selectively radiates surface 62 selectively discharged portions of surface 60 to form an electrostatic image. Developer 54 applies printing material which is selectively attracted or repelled from portions of surface 60 based upon the image of electrostatic fields. For example, in the embodiment illustrated, the printing material applied by developer 54 has the same polarity of charge as surface 60 such that those portions of surface 60 discharged as a result of being irradiated or exposed by imager 52 attract such as toner, having an opposite charge to the charge of surface 60, wherein imager 52 radiates or exposes surface 62 discharged portions of surface 60 where printing material or toner is not desired. Rotation of drum 46 moves the image of printing material into contact or close proximity with sheets 22 carried by media feed 26. Once the image of printing material has been transferred and applied to sheet 22, media feed 26 transfers sheet 22 to fuser 30 which more permanently adheres the printing material to sheet 22. The printed upon sheet 22 is then discharged to output 32. During transport of sheet 22 from input 24 to printing device 28, sheets 22 may become skewed with respect to feed direction 42. This may be the result of many and various factors, including, but not limed to, sheets 22 being fed at a skewed angle, by pick rollers, belts or other components of media feed 26 applying uneven forces to sheet 22 or by sheet 22 itself having edges that are skewed with respect to one another.

Sensors 34 and 36 comprise sensing devices configured to sense and detect skew of sheet 22. In particular, sensors 34 and 36 are configured to detect skew of sheet 22 as sheet 22 is being moved towards printing device 28 by media feed 26. Sensors 34 and 36 are located to sense portions of sheet 22 being transported or moved towards printing device 20 such that signals indicating the detected skew of a portion of sheet 22 are transmitted to controller 38 in a timely manner such that controller 38 may adjust operation of imager 52 to account for the detected skew of the sensed portions of sheet 22 prior to the formation of the electrostatic image upon those portions of surface 60 which will subsequently carry and transfer the printing material to the corresponding sensed portions of sheet 22. At the same time, sensors 34 and 36 are otherwise located as close as possible to printing device 28 so as to minimize the extent to which the skew of the sensed portions of sheet 22 may change from the time such portions are sensed by sensors 34 and 36 and the time at which printing material is applied to such portions of sheet 22. In the example embodiment illustrated, the positioning of sensors 34 and 36 is dependent upon the speed at which sheets 22 are being moved, the rate or speed at which surface 60 is being moved (a diameter of drum 46 and the speed at which drum 46 is rotated), the relative positioning of imager 52 to where printing material is transferred from surface 60 sheets 22 and the time it takes controller 38 to adjust operation of imager 52. As will be described in more detail hereafter, sensors 34 and 36 sense opposite side edges of sheet 22 and transmit signals indicating the determined skew of sheet 22 to controller 28. Although printer 20 is illustrated as including two sensors 32, 34, and other embodiments, printer 20 may alternatively have greater of fewer of such sensors.

Accordingly to one embodiment, sensors 34 and 36 may comprise light emitters and associated light detectors. In such embodiments, light emitted by such light emitters reflects differently off of sheet 22 as compared to an underlying surface behind the sheet 22. The different reflection of light is detected by the light detectors and determined skew. In yet another embodiment, sensor 34 and 36 may comprise optical cameras. In still other embodiments, sensors 34 and 36 may comprise structures which contact side edges 74 and 76 without altering positioning of edges 74 and 76 to determine skew of sheet 22.

Controller 28 comprises a processing unit configured to generate control signals which direct the operation of media feed 26, motor 48, charger 50, imager 52, developer 54, charge eraser 56, fuser 30 and sensors 34, 36. Based upon signals received from sensors 34 and 36, controller 38 further calculates adjustments and based on such adjustments generates control signals directing imager 52 to reposition the electrostatic image being formed by imager 52 upon surface 60. For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, controller 38 may be embodied as part of one or more application-specific integrated circuits (ASICs). Unless otherwise specifically noted, the controller is not limited to any specific combination of hardware circuitry and software, nor to any particular source for the instructions executed by the processing unit.

Although controller 38 is illustrated and described as controlling the operation of media feed 26, fuser 30 or thirty and each of the components of printing device 28, in other embodiments, controller 38 may direct the operation of fewer of such components, wherein additional controllers are provided. For example, in one embodiment, controller 38 may alternatively be associated solely with sensors 34 and 36, wherein controller 38 generates control signals controlling imager 52 based on the image to be formed and the sensed skew of sheet 22.

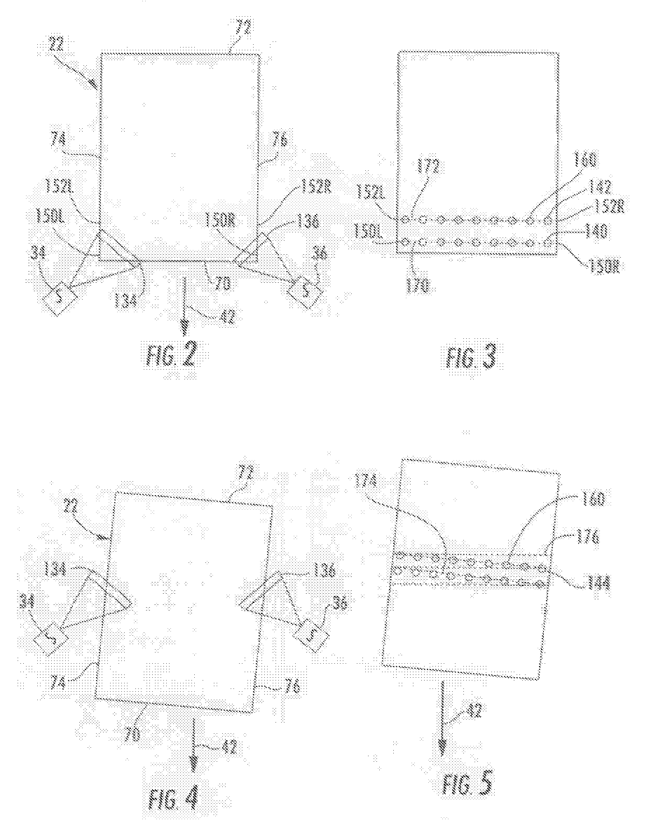

FIGS. 2 to 8 schematically illustrate printer 20 adjusting for skew of sheet 22 relative to feed direction 42. FIGS. 2, 4 and 7 illustrate the feeding of sheet 22 in feed direction 42 and the determination of the skew. FIGS. 3, 5, 6, and 8 illustrate printing adjustments being made by controller 38 to compensate for the sensed skew. As shown by FIG. 2, sheet 22 as a leading edge 70, a trailing edge 72 and opposite side edges 74, 76. As shown by FIG. 2, sensors 34 and 36 (schematically shown) are configured and arranged such that the sensing areas 134, 136 of the sensors 34 and 36, respectively, extend across and sense side edges 74 and 76, respectively, as sheet 22 is moved in feed direction 42. According to one embodiment, sensing areas 134 and 136 are substantially linear and extend at an ankle with respect to side edges 74 and 76. In one embodiment, sensing areas 134 and 136 extend at an angle of about 90° with respect to one another an at an angle of about 45° with respect to media feed direction 42. In other embodiments, sensors 34 and 36 may be arranged such that sensing areas 134 and 136 extend at other angles or have other configurations.

In addition to sensing side edges 74 and 76, sensors 34 and 36 may additionally sense leading edge 70 and trailing edge 72 as sheet 22 is moved in feed direction 42. Sensors 34 and 36 are arranged such that sides 74 and 76 are within sensing areas 134 and 136, respectively, even when sheet 22 is skewed. According to one embodiment, sensors 34 and 36 continuously sense slide edges 74 and 76 as sheet 22 is moved in feed direction 42. In other embodiments, sensors 34, 36 may alternatively be configured to periodically or intermittently sense spaced portions of side edges 74 and 76.

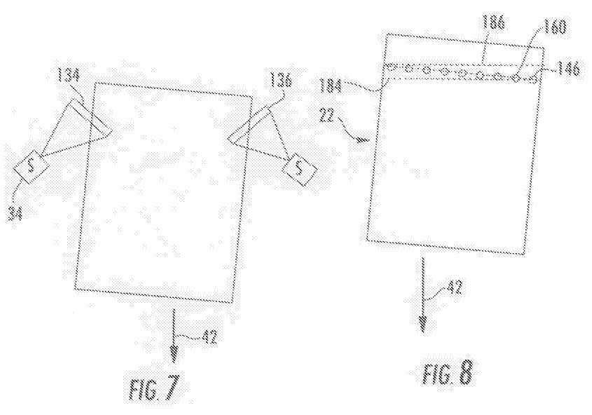

Because sensors 34 and 36 sense multiple portions of side edges 74 and 76. Sensors 74 and 76 may track paper grain to detect relative movement of sheet 22 a long sides 74 and 76 and to detect changes in skew of sheet 22 while sheet 22 is being fed by media feed 26. For example, FIG. 2 illustrates a scenario in which sheet 22 is initially aligned with the direction 42 which is in proper alignment with printing device 28. In the example illustrated, edges 70 and 72 are perpendicular to feed direction 42 while side edges 74 and 76 are parallel to feed direction 42. However, as shown in FIG. 4, sheet 22 has become slightly skewed with respect to feed direction 42. Although sheet 22 is illustrated as being skewed by being rotated in a clockwise direction as seen in FIG. 4, in other scenarios, sheet 22 and alternatively be turned a rotated in a counterclockwise direction. As shown by FIG. 7, he skew of sheet 22 once again changes, becoming less sever. In other scenarios, sheet 22 may alternatively become more skewed or may become skewed in an opposite direction. Such changes in skew may be the result of one or more factors, alone on combination, such as different rollers or belts coming into contact with sheet 22, misaligned or incorrectly located guide surfaces and the like. Because sensors 34 and 36 detect multiple portions of side edges 74 and 76 as sheet 22 is being moved by media feed 26 or between movements of sheet 22 by media feed 26, controller 38 may make multiple adjustments to compensate for the multiple different skews using a detected skew or a detected rate at which skew of sheet 22 is changing as it is being fed to printing device 28 or while it is being printed upon by printing device 28.

Because printer 20 includes a pair of sensors 34 and 36 sensing opposite side edges as well as the top or leading edge 70 of sheet 22, controller 38 may also detect a width of sheet 22 and potentially the type of media of sheet 22 for each sheet 22 being printed upon and as each sheet is being moved through printer 20. In addition, because printer includes sensors 34 and 36 which sense opposite side edges 74 and 76 of sheet 22, controller 38 may also determine the dimensions and shape of sheet 22. For example, controller 38 may determine whether leading edge 70 is not substantially perpendicular to side edges 74 and 76 or whether trailing edge 72 is not substantially perpendicular to one or both of side edges 74 and 76 from signals provided by such sensors. Such information may be used by controller 38 in its generation of control signals for directing the operation of printer 22 correct or compensate for any changes in shape or size of sheet 22. In other embodiments, printer 20 may alternatively be provided with one or more sensor arranged so as to sense one of side edges 74 or 76 without sensing the other of the side edges 74 and 76.

FIGS. 3, 5 and 8 schematically illustrate printing of image lines upon sheet 22 and compensation for any identified skew of sheet 22. FIG. 3 illustrates raster or image lines 140 and 142. Image lines 140 and 142 each comprise a series of dots or marks 160 formed from the printing material of developer 54 printed upon sheet 22. Although marks 160 are illustrated as being circular, marks 160 may have different sizes, shapes and configurations. Image line 140 generally extends from side edge portion 150L to side edge portion 150R. Likewise, image line 142 extends from side edge portion 152L to side edge portion 152R. Marks 160 of image lines 140 and 142 are at locations corresponding to areas along surface 60 (shown in FIG. 1) having sufficiently high electrostatic field strength as created by imager 52 so as to attract charged printing material which is subsequently transferred to sheet 22 as marks 160. To form image line 140, controller 38 generates control signals causing imager 52 to irradiate a line or series of portions of surface 60 (shown in FIG. 1). In one embodiment in which imager 52 comprises a laser, imager 52 scans a pulsed laser beam along scan line 170 (schematically represented by a broken line) across surface 60 (shown in FIG. 1) which upon being rotated will extend opposite to sheet 22. Likewise, to form image line 142, imager 52, in response to control signals from controller 38, scans a pulsed laser beam along scan line 172 across surface 60 which upon being rotated will extend opposite to sheet 22. In the example scenario illustrated in FIGS. 2 and 3, at the particular exposure in time that side edge portions 150L, 150R, 152L and 152R are being sensed by sensors 34 and 36, sheet 22 is not skewed. In other words, sheet 22 is being moved along the direction 42 in alignment with drum 46 and imaging surface 60. As a result, scan lines 170 and 172 along which imaging lines 140 and 142, respectively, are formed extend across sheet 22 parallel to leading edge 70 and trailing edge 72 and perpendicular to side edges 74 and 76. As a result, no skew compensation is provided by controller 38.

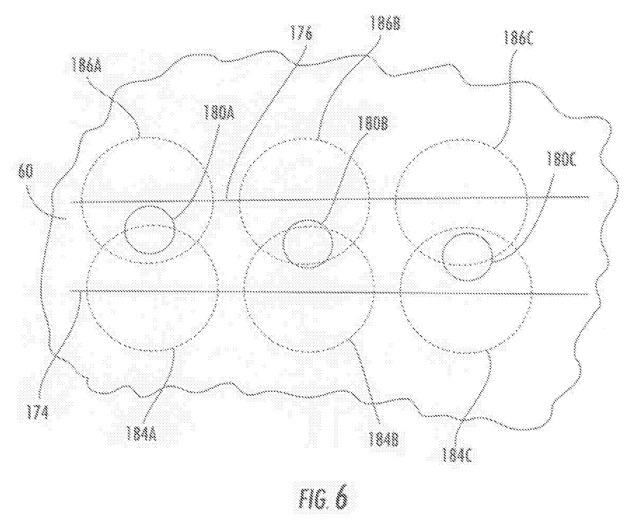

However, as shown by FIG. 4, further movement of sheet 22 by media feed 26 (shown in FIG. 1) resultant sheet 22 becoming skewed. As sheet 22 is moved across sensing areas 134 and 136, sensors 34 and 36 (shown in FIG. 2) sense the skew. As shown in FIG. 5, the skewing of sheet 22 results in sheet 22 becoming misaligned with respect to scan lines 174 and 176 (in FIG. 5) of imager 52 which extend perpendicular to feed direction 42. Without skew compensation, image lines, which are formed by imager 52 along scan lines 174 and lines 176 would also be skewed with respect to sheet 22. In other words, image lines formed upon sheet 22 would obliquely extend relative to side edges 74 76 and leading edge 70 and trailing edge 72 (presuming sheet 22 is substantially rectangular). However, as shown by FIG. 5, controller 38 generates control signals such that imager 52 forms exposures of electrostatic charge along surface 60 between scan lines 174 and 176 such that the resulting image line 144 may gradually transition between scan line 174 and 176 so as to compensate for the skew of sheet 22. In particular, to compensate for the skew of sheet 22, controller 38 generates control signals such that imager 52 forms dots of electrostatic charge along surface 60 such that image line 144 slopes from scan line 176 to scan line 174 at an angle substantially equal to the angle at which sheet 22 is skewed as detected by sensors 34 and 36 in FIG. 4. The end result is that image line 144 extends substantially parallel to leading edge 70 or trailing edge 72 of sheet 22 and perpendicular to side edges 74 and 76.

Although FIG. 5 illustrates image line 144 as being a single continuous line of marks 160 extending from side edge 74 to side edge 76 of sheet 22 between consecutive scan lines 174 and 176, on other embodiments, image line 144 may gradually extend between a pair of nonconsecutive scan lines. For example, if controller 38 determines from signals from sensors 34 and 36 that side 74 is five scan lines lower than the opposite portion of the side 76, controller 38 may generate control signals such that image line 144 gradually transitions from a first scan line to a second nonconsecutive part of neighboring scan lines. As a result, the particular image line would be brought into rough alignment with sheet 22.

In one embodiment, orthogonality of the resulting skewed image on the skewed paper is further enhanced by adjusting for the skewed left and right margins of the image being printed on the sheet. In particular, controller 38 starts particular image line slightly earlier or extends particular image lines slightly farther to accommodate for such skew. In some embodiments, lines can be started a fraction of a dot earlier or later as desired, causing all dots (pixels) on the image line to be slightly shifted. For example, if the image is being rotated clockwise, image lines above a midpoint of sheet 22 are shifted to the right while image lines below the midpoint of sheet 22 are shifted to the left. Adjustments for rotation of the image in a counterclockwise direction any made in an opposite fashion.

FIG. 6 schematically illustrates in more detail how controller 38 generates control signals causing imager 52 to form dots of electrostatic charge that gradually transition between scan lines 174 and 176 on surface 60 of drum 46 to form image line 144 (shown in FIG. 5) on sheet 22 which compensates for skew of sheet 22. FIG. 6 illustrates a portion of surface 60 being irradiated by imager 52 (shown in FIG. 1) to form dots 180A. 180A and 180C (collectively referred to as dots 180) of electorstatic charge on surface 60. Such dots 180 subsequently attract (or repel) charged toner from developer 54 (shown in FIG. 1), wherein the toner is then carried into contact with sheet 22 to form image line 144 (shown in FIG. 5).

As shown by FIG. 6, dots 180A, 180B and 180C gradually transition towards scan line 174. To form intermediate dots 180A, 180B and 180C, controller 38 generates control signals such that the energy level (intensity or duration) of laser beam 62 from imager 52 impinging surface 60 along scan lines 174 and 176 is varied. In particular, cooperating laser or light exposures 184A, 186A, 184B, 186B and 184C, 186C are formed along scan lines 174 and 176, respectively. However, laser or light exposures 184A, 186A, 184B, 186B and 184C, 186C do not sufficiently discharge the irradiated portions along lines 174 and 176 of surface 60 by themselves individually such that those portions of surface 60 attract a sufficient amount of printing material so as to form a visible mark 160 (shown in FIG. 5). Rather, the intensity of exposures 184A, 186A, exposures 184B, 186B and exposures 184C, 186C (which may have a Gaussian distribution) is such that about where such exposures overlap, surface 60 is sufficiently to attract printing material that will form a visible mark 160 upon sheet 22.

The location of dots 180 relative to adjacent scan lines 174 and 176 is dependent upon the relative contribution of exposures 184 and 186 to the combined intermediate exposure overlap. For example, where it is desired that a dot 180 to be equidistantly located between scan lines 174 and 176, the intensity or duration of the overlapping exposures 184, 186 are controlled so as to be substantially equal. As shown by FIG. 6, exposures 186B and 184B are substantially equal such that dot 180B is substantially equidistantly located between scan lines 174 and 176. Where it is desired that a dot be offset closer to scan line 174, the intensity or duration of exposure 184 is controlled so as to be larger than exposure 186. As shown in by FIG. 6, exposure 184C is greater than exposure 186C such that dot 180C is closer to or offset towards scan line 174. Where it is desired that a dot be offset closer to scan line 176, the intensity or duration of exposure 186 is controlled so as to be larger than exposure 184. As shown by FIG. 6, exposure 186A is greater than exposure 184A such that dot 180A is closer to or offset towards scan line 84. The relative strength of exposures 184, 186 may be controlled through power modulation or through time or duration (pulse width) modulation.

FIG. 8 illustrates image or raster line 146 of an image being printed upon sheet 22. As shown in FIG. 8, image line 146 formed by marks 160 gradually transitions from scan line 184 to scan line 186 to compensate for the skew detected by sensors 34 and 36 as seen in FIG. 7. The slope or rate at which image line 146 transitions from scan line 184 towards scan line 186 differs from that of image line 144 shown in FIG. 5 based upon the difference in detected skew of sheet 22 for those portions of sheet 22 being printed upon. As a result, printer 20 may adjust for different degrees of skew as sheet 22 is being fed by media feed 26. At the same time, printer 20 may make different adjustments when printing upon different sheets which may have different degrees of skew. Because printer 20 independently corrects for skew of each sheet, skew may be corrected without increasing cost and tightening mechanical tolerance of parts of media feed 26. In particular embodiments, such skew adjustment provided by printer 20 may enable parts of printer 20 to have relaxed tolerance specifications. Moreover, because each image line is adjusted “on-the-fly,” non-uniform skew adjustments can be corrected. Even expending the time and computing resources to resample the entire image to perform a rotation a priori to accommodate skew would not easily achieve this and may be omitted.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed:

1. A method comprising:
sensing a first portion of a first side edge of a sheet as the sheet is moved in a feed direction to determine a first skew of the first portion of the sheet relative to the feed direction;
adjusting a first line of an image to be printed adjacent the first portion using the determined first skew;
sensing a second portion of the first side edge of the sheet as a sheet is moved in the feed direction to determine a second skew of the second portion of the sheet relative to the feed direction; and
adjusting a second line of the image to be printed adjacent the second portion using the determined second skew.

2. The method of claim 1, wherein adjusting the first line comprises selectively varying energy levels of laser exposures along a first laser scan and a second laser scan to form intermediate dots where such exposures overlap one another and such that the dots shift from the first scan towards the second scan based on the determined first skew.

3. The method of claim 2, wherein adjusting the second line comprises selectively varying energy levels of laser exposures along a third laser scan and a fourth laser scan to form intermediate dots where such exposures overlap one another and such that the dots shift from the third scan towards the fourth scan based on the determined second skew.

4. The method of claim 1, wherein adjusting the first line comprises shifting the first line of the image in a transverse direction relative to the feed direction based on determined first skew.

5. The method of claim 1 further comprising:
sensing a third portion of a second side edge of the sheet as the sheet is moved in the feed direction to determine a third skew of the first portion of the second side edge relative to the feed direction; and
adjusting a third line of an image to be printed adjacent the third portion based on the determined third skew.

6. The method of claim 5, wherein adjusting the third line comprises selectively varying energy levels of laser exposures along a third laser scan and a fourth laser scan to form intermediate dots where such exposures overlap one another and such that the dots shift from the third scan towards the fourth scan based on the determined third skew.

7. The method of claim 1 further comprising continuously sensing the first side edge from a first location adjacent an upper printing margin on the sheet to a second location adjacent a lower printing margin of the sheet.

8. The method of claim 1 further comprising continuously sensing the first side edge from the leading edge of the sheet to the trailing edge of the sheet.

9. A method comprising:
sensing a first skew of a first sheet of media having a leading edge, a trailing edge and a pair of side edges as the sheet is being fed in a printing device;
sensing a second skew of a second sheet of media as the second sheet is being fed in the printing device;
adjusting a first image line at a first location on the first sheet; and
adjusting a second image line at the same location on the second sheet differently than the first line, wherein adjusting the first line and adjusting the second line each comprises selectively varying energy levels of laser exposures along a first laser scan and a second laser scan to form intermediate dots where such exposures overlap one another and such that the dots shift from the first scan towards the second scan based on the sensed skew.

10. The method of claim 9, wherein sensing the first skew of the first sheet comprises sensing a first side edge of the first sheet.

11. The method of claim 10 further comprising sensing a second scan based on the first sheet.

12. The method of claim 9 further comprising sensing a first portion of the first side edge and a second portion of the first side edge.

13. The method of claim 9 further comprising continuously sensing the first side edge from a first location adjacent an upper printing margin on the sheet to a second location adjacent a lower printing margin of the sheet.

14. The method of claim 9 further comprising continuously sensing the first side edge from the leading edge of the sheet to the trailing edge of the sheet.

15. The method of claim 9, wherein adjusting the first line comprises shifting the first line of the image in a transverse direction relative to the feed direction based on determined first skew.

16. A printer comprising:
a printing device configured to form an image upon a sheet of media;
a media feed device configured to feed the sheet having a side edge in a feed direction to the printing device;
a first sensor configured to sense the side edge of the sheet after initiating feeding of the sheet by the feed device to determine a skew of the sheet relative to the feed direction; and
a controller configured to generate control signals based on an image to be printed and the sensed skew of the sheet, wherein the printing device forms an image on the sheet to response to the control signals.

17. The printer of claim 16, wherein the printing device comprises an imaging surface configured to selectively retain electrostatic charge.

18. The printer of claim 17, wherein the controller is configured to adjust printing of lines of the image by generating the control signals such that electrostatic fields of a neighboring first raster line and a second raster line on the imaging surface overlap to form intermediate dots that shift from the first raster line to the second raster line based on the determined skew.

19. The printer of claim 18 wherein the image surface comprises a photosensitive surface and wherein the printing device further includes a laser configured to selectively irradiate portions of the photosensitive surface along the first and second raster lines to form the intermediate dots.

20. The printer of claim 16 further comprising a second sensor configured to sense a second side edge of the sheet after initiation of feeding of the sheet by the feeding device to determine a skew of the sheet relative to the feed direction.
